(19) United States
(12) Patent Application Publication
(10) Pub. No.: US 2026/0109619 A1
(43) Pub. Date: Apr. 23, 2026

(54) CONTROLLING DIELECTRIC CONSTANT OF FE-HFO2

(71) Applicant: Samsung Electronics Co., Ltd., Suwon-si (KR)

(72) Inventors: Nikhil SIVADAS, Boston, MA (US); Yongwoo Shin, Concord, MA (US); Ali Hamze, Dorchester, MA (US); Anubhab Haldar, Allston, MA (US)

(73) Assignee: SAMSUNG ELECTRONICS CO., LTD., Suwon-si (KR)

(21) Appl. No.: 19/069,994

(22) Filed: Mar. 4, 2025

Related U.S. Application Data
(60) Provisional application No. 63/710,333, filed on Oct. 22, 2024.

(51) Int. Cl. C01G 27/02

(52) U.S. Cl. CPC C01G 27/02; C01P 2002/54; C01P 2002/76; C01P 2006/40

(57) ABSTRACT

A meta-stable ferroelectric structure which can increase or decrease the dielectric constant (κ) of HfO₂ includes one of: (1) to decrease κ, Hf₁₋ₓMₓO_{2-δ}; M={Mo, W, Mn, V, Cr}, 0<x<1, 0≤δ≤0.5; (ii) to decrease κ, Hf₁₋ₓMₓO_{2-δ}; M={Os, Ru}, 0<x≤0.25, 0≤δ≤0.5; and (iii) to increase κ, Hf₁₋ₓM′ₓO_{2-δ}; M′={Ti, Te, Se, Pd, Pb}, 0<x<1, 0≤δ≤0.5; or a combination thereof.

### CROSS-REFERENCE TO RELATED APPLICATION

This application is based on and claims priority from U.S. Provisional Application No. 63/710,333 filed on Oct. 22, 2024 in the U.S. Patent and Trademark Office, the disclosure of which is incorporated herein by reference in its entirety.

### BACKGROUND

### 1. Field

Embodiments relate to a meta-stable ferroelectric structure which can increase or decrease the dielectric constant (κ) of HfO₂, comprising one of: (i) to decrease κ, Hf₁₋ₓMₓO_{2-δ}; M={Mo, W, Mn, V, Cr}, 0<x<1, 0≤δ≤0.5; (ii) to decrease κ, Hf₁₋ₓMₓO_{2-δ}; M={Os, Ru}, 0<x≤0.25, 0≤δ≤0.5; and (iii) to increase κ, Hf₁₋ₓM′ₓO_{2-δ}; M′={Ti, Te, Se, Pd, Pb}, 0<x<1, 0≤δ≤0.5; or a combination thereof.

### 2. Description of the Related Art

Ferroelectricity (FE) in HfO₂ was first observed in 2011, many years after its commercial use as a gate-dielectric material. This FE is unique in the sense that it is persistent in thin-films. Later, ZrO₂ was also found to form FE in this phase.

Ferroelectric HfO₂ is illustrated in FIG. 1. In this regard, FIG. 1 shows two distinct states (polarization up and polarization down). An electric field is used to switch the states.

Typical applications of ferroelectric materials include the following:
Non-volatile memory devices-Polarization stays (“1”) when the field is removed. The polarization can be switched on application of a different field (“0”). Applications for FE-RAMs are currently being explored.
Tunnel junctions: FTJs are explored in diode-like applications. FEFETs are also being explored.
Capacitors-Some FE materials exhibit a high dielectric constant. This is useful for better capacitors.
Sensors-Sensitivity to E-field allows FE materials to be used as RF and IR sensors. They are also used in ultrasound applications, as optical components, and as tunable microwave components (high coercive field allows microwave tunability at <3V).
Other applications include piezoelectrics, detectors for vibration, pyroelectricity, etc.

HfO₂ is often used for the following reasons:
CMOS compatible: HfO₂ has been used as a high-k gate dielectric for over 2 decades.
Typical FE materials lose their FE property in thin film, but HfO₂ retains its FE property in thin film (even down to 1 nm).

FE in HfO₂ was observed only in 2011, but little progress has been made since then on controlling dielectric constant of the FE-phase.

Challenges with existing HfO₂ technology include the following:
The FE phase of HfO₂ (Pca2₁) is not the lowest energy phase of HfO₂ (Ehull˜28 meV/atom). This is typically stabilized by using an appropriate substrate (SiO₂) or by doping (Si, Al, Y, etc.).
Identifying chemistries to dope HfO₂ that are stable in the polar phases (Pca2₁) with low Ehull, that can control (increase and decrease) the dielectric constant (κ) can have important technological impact. Two examples:
   Increasing κ can have a tangible impact in applications including capacitors.
   Decreasing κ can improve the interface quality of FE-dielectric interfaces in FE-FETs.

In view of the above, there is a need to identify stable chemistries that when doped into HfO₂ retain the FE.

Information disclosed in this Background section has already been known to the inventors before achieving the disclosure of the present application or is technical information acquired in the process of achieving the disclosure. Therefore, it may contain information that does not form the prior art that is already known to the public.

### SUMMARY

To satisfy the above need, the present disclosure identifies stable chemistries that when doped into HfO₂ retain the FE. This will expand the candidates for thin film FE applications and provide a control knob for tuning the dielectric properties.

In particular, the present disclosure identifies elements that when doped into HfO₂ lead to meta-stable ferroelectric structures which can increase and decrease the dielectric constant (κ) of HfO₂.

The criteria for the search used in connection with the present disclosure include constraints on change in volume relative to HfO₂, relative thermodynamic stability, Shannon radius of dopant atoms, band gap and computed dielectric constant.

The present disclosure expands the list of possible oxide FE from just two chemistries (Hf, Zr) to many others. By tuning the dopant candidates, the present disclosure can control (both decrease and increase) the dielectric constant of HfO₂.

The list of chemistries provided by the present disclosure gives considerable flexibility in making thin film FEs. By changing the chemistries and ratios, the present disclosure enables the control of dielectric constant and possibly other functionalities.

A first embodiment of the present disclosure provides a meta-stable ferroelectric structure which can increase or decrease the dielectric constant (κ) of HfO₂, comprising one of:

$$- to decrease κ , {Hf}_{1 - x} {M}_{x} {O}_{2 - δ} ; M = \{ Mo , W , Mn , V , Cr \} , 0 < x < 1 , 0 \leq δ \leq 0.5 ; \\ - to decrease κ , {Hf}_{1 - x} {M}_{x} {O}_{2 - δ} ; M = \{ Os , Ru \} , 0 < x \leq 0.25 , 0 \leq δ \leq 0.5 ; \\ - to increase κ , {Hf}_{1 - x} {M}_{x}^{′} {O}_{2 - δ} ; {M}^{′} = \{ Ti , Te , Se , Pd , Pb \} , 0 < x < 1 , 0 \leq δ \leq 0.5 ;$$

or a combination thereof.

A second embodiment of the present disclosure provides a meta-stable ferroelectric structure of the first embodiment, comprising Hf₁₋ₓMₓO_{2-δ}; M={Mo, W, Mn, V, Cr}, 0<x<1, 0≤δ≤0.5 to decrease κ.

A third embodiment of the present disclosure provides a meta-stable ferroelectric structure of the first embodiment, comprising Hf₁₋ₓMₓO_{2-δ}; M={Os, Ru}, 0<x≤0.25, 0≤δ≤0.5 to decrease κ.

A fourth embodiment of the present disclosure provides a meta-stable ferroelectric structure of the first embodiment, comprising Hf₁₋ₓM′ₓO_{2-δ}; M′={Ti, Te, Se, Pd, Pb}, 0<x<1, 0≤δ≤0.5 to increase κ.

A fifth embodiment of the present disclosure provides a meta-stable ferroelectric structure of the first embodiment, comprising Hf₁₋ₓMₓO_{2-δ}; M={Mo, W, Mn}, 0<x<1, 0≤δ≤ 0.5 to decrease κ.

A sixth embodiment of the present disclosure provides a meta-stable ferroelectric structure of the first embodiment, comprising Hf₁₋ₓM′ₓO_{2-δ}; M′={Ti, Te}, 0<x<1, 0≤δ≤0.5 to increase κ.

A seventh embodiment of the present disclosure provides a meta-stable ferroelectric structure of the first embodiment, comprising Hf₁₋ₓMₓO_{2-δ}; M={V, Cr}, 0<x<1, 0≤δ≤0.5 to decrease κ.

A eighth embodiment of the present disclosure provides a meta-stable ferroelectric structure of the first embodiment, comprising Hf₁₋ₓMₓO_{2-δ}; M=Mo, 0<x<1, 0≤δ≤0.5 to decrease κ.

An ninth embodiment of the present disclosure provides a meta-stable ferroelectric structure of the first embodiment, comprising Hf₁₋ₓMₓO_{2-δ}; M=W, 0<x<1, 0≤δ≤0.5 to decrease κ.

A tenth embodiment of the present disclosure provides a meta-stable ferroelectric structure of the first embodiment, comprising Hf₁₋ₓMₓO_{2-δ}; M=Mn, 0<x<1, 0≤δ≤0.5 to decrease κ.

A eleventh embodiment of the present disclosure provides a meta-stable ferroelectric structure of the first embodiment, comprising Hf₁₋ₓM′ₓO_{2-δ}; M′=Ti, 0<x<1, 0≤δ≤ 0.5 to increase κ.

A twelfth embodiment of the present disclosure provides a meta-stable ferroelectric structure of the first embodiment, comprising Hf₁₋ₓM′ₓO_{2-δ}; M′=Te, 0<x<1, 0≤δ≤0.5 to increase κ.

A thirteenth embodiment of the present disclosure provides a meta-stable ferroelectric structure of the first embodiment, comprising said combination thereof.

A fourteenth embodiment of the present disclosure provides an application comprising the meta-stable ferroelectric structure of the first embodiment, wherein the application is selected from a vertical channel transistor, FE-RAM, FE-FET, FTJ, capacitor, sensor, and switch.

A fifteenth embodiment of the present disclosure provides an application comprising the meta-stable ferroelectric structure of the second embodiment, wherein the application is selected from a vertical channel transistor, FE-RAM, FE-FET, FTJ, capacitor, sensor, and switch.

A sixteenth embodiment of the present disclosure provides an application comprising the meta-stable ferroelectric structure of the third embodiment, wherein the application is selected from a vertical channel transistor, FE-RAM, FE-FET, FTJ, capacitor, sensor, and switch.

A seventeenth embodiment of the present disclosure provides an application comprising the meta-stable ferroelectric structure of the fourth embodiment, wherein the application is selected from a vertical channel transistor, FE-RAM, FE-FET, FTJ, capacitor, sensor, and switch.

A eighteenth embodiment of the present disclosure provides an application comprising the meta-stable ferroelectric structure of the fifth embodiment, wherein the application is selected from a vertical channel transistor, FE-RAM, FE-FET, FTJ, capacitor, sensor, and switch.

A nineteenth embodiment of the present disclosure provides an application comprising the meta-stable ferroelectric structure of the sixth embodiment, wherein the application is selected from a vertical channel transistor, FE-RAM, FE-FET, FTJ, capacitor, sensor, and switch.

A twentieth embodiment of the present disclosure provides an application comprising the meta-stable ferroelectric structure of the seventh embodiment, wherein the application is selected from a vertical channel transistor, FE-RAM, FE-FET, FTJ, capacitor, sensor, and switch.

### BRIEF DESCRIPTION OF DRAWINGS

The patent or application file contains at least one drawing executed in color. Copies of this patent or patent application publication with color drawing(s) will be provided by the Office upon request and payment of the necessary fee.

Example embodiments of the present disclosure will be more clearly understood from the following detailed description taken in conjunction with the accompanying drawing in which:

FIG. 1 shows ferroelectric HfO₂ in its two distinct states.

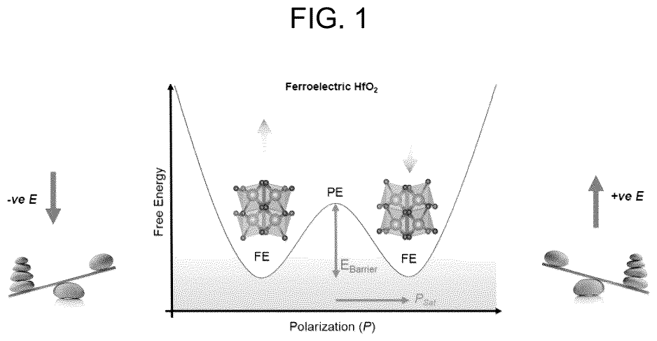

FIG. 2 shows the FE-HfO₂ structure with space group Pca2₁.

FIG. 3 shows polarization and decreased dielectric constant vs. doping (Mo).

FIG. 4 shows polarization and increased dielectric constant vs. doping (Ti).

FIG. 5 shows the NEB barrier vs. Mo doping for a constraint lattice.

FIG. 6 shows the NEB barrier vs. Ti doping for a constraint lattice.

### DETAILED DESCRIPTION OF EXAMPLE EMBODIMENTS

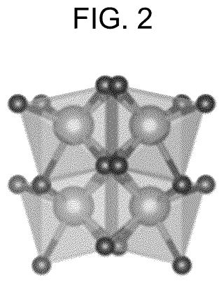

As mentioned above, FIG. 2 shows the FE-HfO₂ structure with space group Pca2₁.

Based on a systematic study of all possible isovalent oxides that are meta-stable in the FE phases of HfO₂, the present disclosure identifies the following chemistries that when doped to HfO₂ lead to meta-stable ferroelectric structures which can increase and decrease the dielectric constant (κ) of HfO₂:

$$- to decrease κ , {Hf}_{1 - x} {M}_{x} {O}_{2 - δ} ; M = \{ Mo , W , Mn , V , Cr \} , 0 < x < 1 , 0 \leq δ \leq 0.5 ; \\ - to decrease κ , {Hf}_{1 - x} {M}_{x} {O}_{2 - δ} ; M = \{ Os , Ru \} , 0 < x \leq 0.25 , 0 \leq δ \leq 0.5 ; \\ - to increase κ , {Hf}_{1 - x} {M}_{x} {O}_{2 - δ} ; {M}^{′} = \{ Ti , Te , Se , Pd , Pb \} , 0 < x < 1 , 0 \leq δ \leq 0.5 ,$$

or combinations of elements above (M and M′).

They can be used in applications including Vertical channel transistors, FE-RAM, FE-FET, FTJ, capacitors, sensors and switches.

The identified chemistries to dope HfO₂ are nonmetallic with at least 1 eV band gap with relatively low Ehull (<150 meV/atom), making them experimentally synthesizable under appropriate conditions (including choosing the right substrate—this is reflected in constraining the volume change for 50% doping to within 5% of FE-HfO₂).

The ferroelectrics can be grown on an appropriate substrate of choice using typical growth methods like thermal oxidation, atomic layer deposition, pulsed laser deposition, chemical vapor deposition, plasma oxidation, wet anodization or other chemical treatments, and they can be doped with a dopant of the present disclosure by a typical doping method. For example, atomic layer deposition growth of HfO₂ can be done using CpHf(NMe₂)₃ and (CpMe)Hf(NMe₂)₃ (Cp, cyclopentadienyl=C₅H₅) as precursors using O₃ as the oxygen source between 250° C. and 400° C., and they can be doped with a dopant of the present disclosure by a typical doping method.

Thus, Table 1 as set forth below shows the control of the dielectric constant of FE-HfO₂ with 25% doping:

TABLE 1
Controlling dielectric constant of FE-HfO₂ (25% doping)

| element | shannon r | e_hull | band gap | a | b | c | Volume | delta V % | Ionic k | Electric k | Total k | delta k % |
|---|---|---|---|---|---|---|---|---|---|---|---|---|
| HfO2 | 0.710 | 0.028 | 4.385 | 5.046 | 5.078 | 5.270 | 135.036 | — | 19.880 | 5.007 | 24.885 | — |
| (‘Hf’ ‘O’, ‘Se’) | 0.500 | 0.089 | 3.366 | 5.124 | 5.103 | 5.286 | 138.217 | 2.356 | 21.025 | 5.346 | 26.370 | 5.963 |
| (‘Hf’ ‘O’, ‘Os') | 0.630 | 0.177 | 0.498 | 5.037 | 5.048 | 5.200 | 132.219 | −2.086 | 15.259 | 6.918 | 22.176 | −10.889 |
| (‘Hf’ ‘Mn’, ‘O’) | 0.530 | 0.058 | 1.193 | 5.040 | 5.099 | 5.325 | 136.847 | 1.341 | 15.235 | 6.227 | 21.462 | −13.761 |
| (‘Hf’ ‘Mo’, ‘O’) | 0.650 | 0.047 | 2.601 | 5.043 | 5.062 | 5.255 | 134.148 | −0.658 | 16.592 | 5.441 | 22.034 | −11.462 |
| (‘Hf’ ‘O’, ‘V’) | 0.580 | 0.049 | 1.917 | 4.992 | 5.083 | 5.390 | 136.768 | 1.282 | 18.810 | 5.415 | 24.225 | −2.657 |
| (‘Hf’ ‘O’, ‘Te’) | 0.970 | 0.087 | 3.012 | 5.135 | 5.145 | 5.354 | 141.450 | 4.750 | 38.571 | 5.757 | 44.329 | 78.126 |
| (‘Hf’ ‘O’, ‘Rh’) | 0.600 | 0.116 | 0.034 | 5.012 | 5.153 | 5.402 | 139.517 | 3.318 | 48.668 | 32.858 | 81.527 | 227.597 |
| (‘Ge’ ‘Hf’, ‘O’) | 0.530 | 0.044 | 4.080 | 5.015 | 5.070 | 5.376 | 136.690 | 1.225 | 17.185 | 4.789 | 21.975 | −11.699 |
| (‘Co’ ‘Hf’, ‘O’) | 0.530 | 0.139 | 0.222 | 4.981 | 5.077 | 5.295 | 133.903 | −0.839 | 22.205 | 10.080 | 32.285 | 29.731 |
| (‘Hf’ ‘O’, ‘W’) | 0.660 | 0.047 | 3.414 | 5.056 | 5.079 | 5.265 | 133.202 | 0.123 | 15.872 | 5.144 | 21.016 | −15.551 |
| (‘Hf’ ‘O’, ‘Pd’) | 0.615 | 0.053 | 1.238 | 5.097 | 5.177 | 5.349 | 141.145 | 4.524 | 18.478 | 6.908 | 25.386 | 2.009 |
| (‘Fe’ ‘Hf’, ‘O’) | 0.585 | 0.107 | 0.000 | 5.039 | 5.100 | 5.236 | 134.559 | −0.353 | 25.331 | 112.813 | 138.145 | 455.104 |
| (‘Hf’ ‘O’, ‘Sn’) | 0.690 | 0.035 | 3.789 | 5.103 | 5.169 | 5.452 | 143.810 | 6.497 | 19.094 | 4.783 | 23.877 | −4.056 |
| (‘Hf’ ‘O’, ‘Pb’) | 0.775 | 0.052 | 1.901 | 5.116 | 5.167 | 5.363 | 141.768 | 4.985 | 20.277 | 5.978 | 26.255 | 5.502 |
| (‘Hf’ ‘O’, ‘Zr’) | 0.720 | 0.027 | 4.113 | 5.069 | 5.093 | 5.285 | 136.440 | 1.039 | 21.348 | 5.159 | 26.507 | 6.513 |
| (‘Hf’ ‘O’, ‘Ta’) | 0.680 | 0.101 | 0.000 | 5.027 | 5.066 | 5.253 | 133.777 | −0.933 | 46.808 | 57.660 | 104.468 | 319.782 |
| (‘Hf’ ‘O’, ‘Pt’) | 0.625 | 0.076 | 1.608 | 5.000 | 5.200 | 5.468 | 142.168 | 5.281 | 21.263 | 5.848 | 27.109 | 8.930 |
| (‘Hf’ ‘Ir’, ‘O’) | 0.623 | 0.137 | 0.000 | 5.017 | 5.179 | 5.437 | 141.270 | 4.616 | 22.616 | 40.899 | 63.515 | 155.222 |
| (‘Hf’ ‘O’, ‘Si’) | 0.400 | 0.123 | 4.425 | 5.029 | 5.033 | 5.314 | 134.502 | −0.395 | 11.938 | 4.547 | 16.485 | −33.760 |
| (‘Hf’ ‘Ni’, ‘O’) | 0.480 | 0.184 | 0.000 | 5.014 | 5.061 | 5.210 | 132.208 | −2.094 | 15.838 | 47.617 | 63.455 | 154.980 |
| (‘Hf’ ‘O’, ‘Re’) | 0.630 | 0.205 | 0.001 | 5.026 | 5.040 | 5.204 | 131.823 | −2.380 | 15.680 | 16.488 | 32.168 | 29.260 |
| (‘Hf’ ‘Nb’, ‘O’) | 0.680 | 0.077 | 0.014 | 5.035 | 5.083 | 5.256 | 134.516 | −0.385 | 48.585 | 79.019 | 127.604 | 412.748 |
| (‘Cr’ ‘Hf’, ‘O’) | 0.550 | 0.071 | 1.158 | 4.987 | 5.056 | 5.329 | 134.367 | −0.496 | 18.981 | 5.866 | 24.847 | −0.160 |
| (‘Hf’ ‘O’, ‘Ru’) | 0.620 | 0.170 | 0.245 | 5.023 | 5.037 | 5.204 | 131.666 | −2.496 | 15.161 | 8.043 | 23.204 | −6.760 |
| (‘Hf’ ‘O’, ‘Ti’) | 0.605 | 0.039 | 3.100 | 4.999 | 5.075 | 5.396 | 136.896 | 1.377 | 30.976 | 5.364 | 36.340 | 46.024 |

Final Criteria: Eₕᵤₗₗ <150 meV/atom, E_{g} >1.0 eV, Δ|V| <5%
>10% decrease; W, Mo, Ge, Mn, Si
>10% increase; Ti, Te
<10% decrease; V, Cr
<10% increase; Zr, Pb, Pd, Se
Others: Sn, Os, Ru

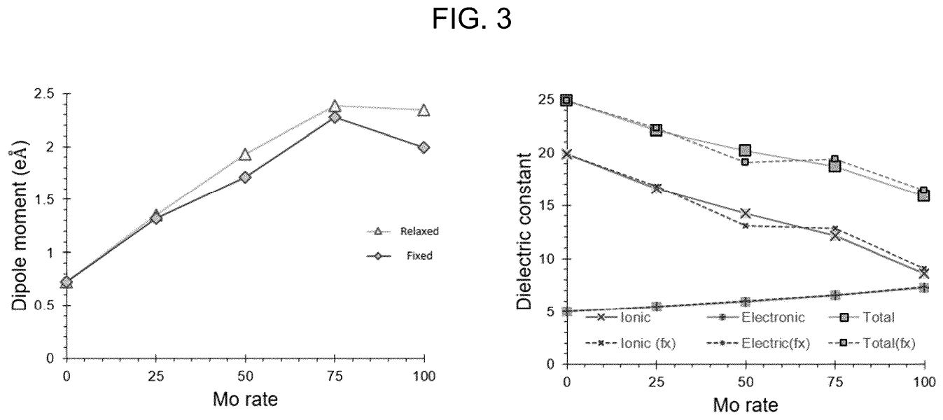

FIG. 3 shows polarization and decreased dielectric constant vs. doping (Mo). As can be seen in FIG. 3, the saturated polarization (yellow) increases with Mo doping. This can be useful for low voltage switching applications (as E.P is lower). The values around 50% doping are about 2.5 times the saturated value in FE-HfO₂. Also, the total dielectric constant (gray) decreases with Mo doping. At 50% doping, the dielectric constant is about 20% lower than FE-HfO₂.

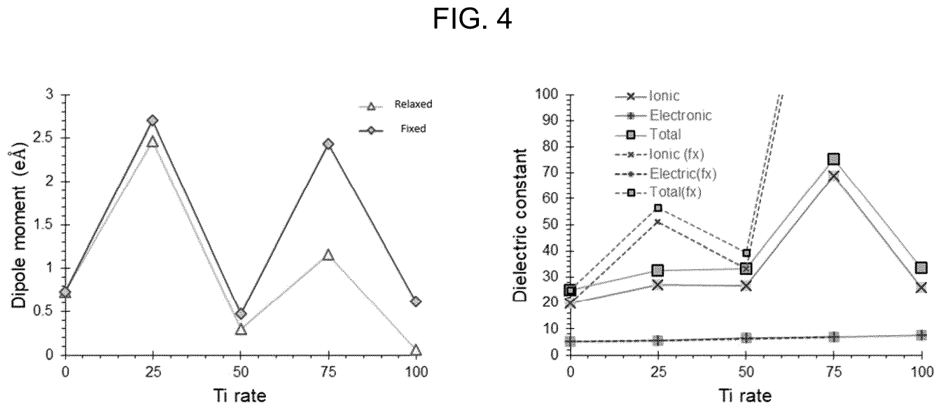

FIG. 4 shows polarization and increased dielectric constant vs. doping (Ti). As can be seen in FIG. 4, the saturated polarization (yellow) fluctuates with Ti doping. For 25% and 75% doping the polarization can be about 3 times the saturated value in FE-HfO₂. This can be useful for low voltage switching applications (as E.P is lower). Also, the total dielectric constant (gray) also fluctuates with Ti doping. However, in general, it is higher than FE-HfO₂. For appropriate intermediate values, the dielectric constant can be very large (˜3× for 25% doping and ˜4× for 75% doping).

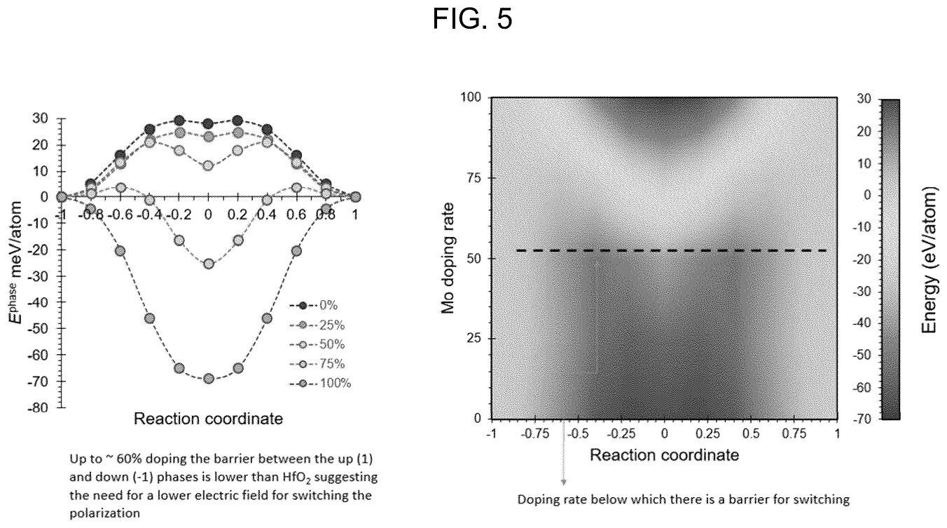

FIG. 5 shows the NEB barrier vs. Mo doping for a constraint lattice. Up to ˜60% doping the barrier between the up (1) and down (−1) phases is lower than HfO₂, suggesting the need for a lower electric field for switching the polarization. FIG. 5 shows the doping rate below which there is a barrier for switching.

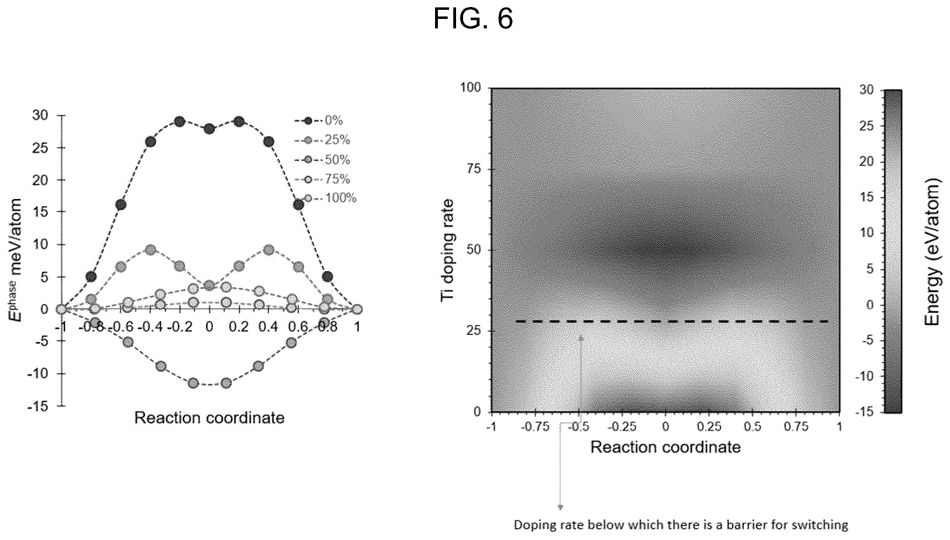

FIG. 6 shows the NEB barrier vs. Ti doping for a constraint lattice. FIG. 6 shows the doping rate below which there is a barrier for switching.

The foregoing is illustrative of exemplary embodiments and is not to be construed as limiting the disclosure. Although a few exemplary embodiments have been described, those skilled in the art will readily appreciate that many modifications are possible in the above embodiments without materially departing from the disclosure.

What is claimed is:

1. A meta-stable ferroelectric structure which can increase or decrease the dielectric constant (κ) of HfO₂, comprising one of:
$$- to decrease κ , {Hf}_{1 - x} {M}_{x} {O}_{2 - δ} ; M = \{ Mo , W , Mn , V , Cr \} , 0 < x < 1 , 0 \leq δ \leq 0.5 ; \\ - to decrease κ , {Hf}_{1 - x} {M}_{x} {O}_{2 - δ} ; M = \{ Os , Ru \} , 0 < x \leq 0.25 , 0 \leq δ \leq 0.5 ; \\ - to increase κ , {Hf}_{1 - x} {M}_{x} {O}_{2 - δ} ; {M}^{′} = \{ Ti , Te , Se , Pd , Pb \} , 0 < x < 1 , 0 \leq δ \leq 0.5 ;$$
or a combination thereof.

2. The meta-stable ferroelectric structure of claim 1, comprising Hf₁₋ₓMₓO_{2-δ}; M={Mo, W, Mn, V, Cr}, 0<x<1, 0≤δ≤0.5 to decrease κ.

3. The meta-stable ferroelectric structure of claim 1, comprising Hf₁₋ₓMₓO_{2-δ}; M={Os, Ru}, 0<x≤0.25, 0<δ≤0.5 to decrease κ.

4. The meta-stable ferroelectric structure of claim 1, comprising Hf₁₋ₓM′ₓO_{2-δ}; M′={Ti, Te, Se, Pd, Pb}, 0<x<1, 0≤δ≤0.5 to increase κ.

5. The meta-stable ferroelectric structure of claim 1, comprising Hf₁₋ₓMₓO_{2-δ}; M={Mo, W, Mn}, 0<x<1, 0≤δ≤0.5 to decrease κ.

6. The meta-stable ferroelectric structure of claim 1, comprising Hf₁₋ₓM′ₓO_{2-δ}; M′={Ti, Te}, 0<x<1, 0≤δ≤0.5 to increase κ.

7. The meta-stable ferroelectric structure of claim 1, comprising Hf₁₋ₓMₓO_{2-δ}; M={V, Cr}, 0<x<1, 0≤δ≤0.5 to decrease κ.

8. The meta-stable ferroelectric structure of claim 1, comprising Hf₁₋ₓMₓO_{2-δ}; M=Mo, 0<x<1, 0≤δ≤0.5 to decrease κ.

9. The meta-stable ferroelectric structure of claim 1, comprising Hf₁₋ₓMₓO_{2-δ}; M=W, 0<x<1, 0≤δ≤0.5 to decrease κ.

10. The meta-stable ferroelectric structure of claim 1, comprising Hf₁₋ₓMₓO_{2-δ}; M=Mn, 0<x<1, 0≤δ≤0.5 to decrease κ.

11. The meta-stable ferroelectric structure of claim 1, comprising Hf₁₋ₓM′ₓO_{2-δ}; M′=Ti, 0<x<1, 0≤δ≤0.5 to increase κ.

12. The meta-stable ferroelectric structure of claim 1, comprising Hf₁₋ₓM′ₓO_{2-δ}; M′=Te, 0<x<1, 0≤δ≤0.5 to increase κ.

13. The meta-stable ferroelectric structure of claim 1, comprising said combination thereof.

14. An application comprising the meta-stable ferroelectric structure of claim 1, wherein the application is selected from a vertical channel transistor, FE-RAM, FE-FET, FTJ, capacitor, sensor, and switch.

15. An application comprising the meta-stable ferroelectric structure of claim 2, wherein the application is selected from a vertical channel transistor, FE-RAM, FE-FET, FTJ, capacitor, sensor, and switch.

16. An application comprising the meta-stable ferroelectric structure of claim 3, wherein the application is selected from a vertical channel transistor, FE-RAM, FE-FET, FTJ, capacitor, sensor, and switch.

17. An application comprising the meta-stable ferroelectric structure of claim 4, wherein the application is selected from a vertical channel transistor, FE-RAM, FE-FET, FTJ, capacitor, sensor, and switch.

18. An application comprising the meta-stable ferroelectric structure of claim 5, wherein the application is selected from a vertical channel transistor, FE-RAM, FE-FET, FTJ, capacitor, sensor, and switch.

19. An application comprising the meta-stable ferroelectric structure of claim 6, wherein the application is selected from a vertical channel transistor, FE-RAM, FE-FET, FTJ, capacitor, sensor, and switch.

20. An application comprising the meta-stable ferroelectric structure of claim 7, wherein the application is selected from a vertical channel transistor, FE-RAM, FE-FET, FTJ, capacitor, sensor, and switch.
